(19) United States
(12) Patent Application Publication
(10) Pub. No.: US 2025/0376625 A1
(43) Pub. Date: Dec. 11, 2025

(54) DISPERSION LIQUID, COATING MATERIAL FOR FORMING RESIN FILM, RESIN FILM, AND MEMBER

(71) Applicant: CANON KABUSHIKI KAISHA, Tokyo (JP)

(72) Inventors: YASUTOMO TSUJI, Saitama (JP); YUJI KITANO, Kanagawa (JP); MASATSUGU TOYONORI, Kanagawa (JP); NAOKO KASAI, Kanagawa (JP); MAKOTO SOUMA, Kanagawa (JP); YUTARO YOSHIDA, Kanagawa (JP)

(21) Appl. No.: 19/298,483

(22) Filed: Aug. 13, 2025

Related U.S. Application Data
(63) Continuation of application No. PCT/JP2024/005798, filed on Feb. 19, 2024.

(30) Foreign Application Priority Data
Feb. 21, 2023 (JP) 2023-025006
Jul. 7, 2023 (JP) 2023-112514

(51) Int. Cl. C09K 23/16; C08K 3/08; C08K 3/22; C09D 4/00; C09D 5/02; C09D 7/20; C09D 7/61; C09K 23/00

(52) U.S. Cl. CPC C09K 23/16; C08K 3/22; C09D 4/00; C09D 5/027; C09D 7/20; C09D 7/61; C09K 23/017; C08K 2003/0875; C08K 2003/2231; C08K 2201/001

(57) ABSTRACT

A dispersion liquid is provided, which contains antimony-containing tin oxide particles, an acidic compound, a basic compound, and a dispersion medium, wherein the basic compound has a molecular weight of 180 to 500 and is at least one compound selected from the group consisting of secondary amines and tertiary amines represented by the following formula (1), the dispersion liquid has a pH higher than an isoelectric point of the antimony-containing tin oxide particles, and the pH of the dispersion liquid assumes a value closer to the isoelectric point during a process of evaporating the dispersion medium from the dispersion liquid:

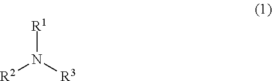

(In formula (1), R¹ and R² each independently represent an aliphatic hydrocarbon group, and R³ represents a hydrogen atom or an aliphatic hydrocarbon group.)

### CROSS-REFERENCE TO RELATED APPLICATIONS

This application is a Continuation of International Patent Application No. PCT/JP2024/005798, filed Feb. 19, 2024, which claims the benefit of Japanese Patent Application No. 2023-025006, filed Feb. 21, 2023, and Japanese Patent Application No. 2023-112514, filed Jul. 7, 2023, both of which are hereby incorporated by reference herein in their entirety.

### BACKGROUND

### Field of the Technology

The present disclosure relates to a dispersion liquid, a coating material for forming a resin film, a resin film, and a member.

### Description of the Related Art

A dispersion liquid in which antimony-containing tin oxide (hereinafter, ATO) particles, which are transparent to visible light, are dispersed in a dispersion medium can be mixed with a binder resin such as an acrylic resin or a urethane resin to create a coating material having high transparency and excellent conductivity. Therefore, ATO particles are often used in electrical and electronic material applications such as electrode materials for liquid crystal and organic EL displays, electrode materials for solar power generation, photosensitive members used in electrophotographic devices, and conductive layers for intermediate transfer belts.

In addition, since ATO particles have the property of absorbing electromagnetic waves such as infrared rays and ultraviolet rays, a transparent resin film that can block heat rays such as infrared rays can be easily produced by forming on a base material a film of a resin coating material containing ATO particles. Such a coating material is used in fields where infrared and ultraviolet blocking properties are required, such as window materials for automobiles, trains, ships, and houses.

Japanese Patent Laid-Open No. 2005-187580 discloses a dispersion liquid of ATO particles with small dispersed particle diameter and excellent dispersion stability as a result of adding an amine compound having a molecular weight of 1000 to 30,000 expressed by a specific formula.

Japanese Patent Laid-Open No. 2007-211155 discloses a coating film in which metal oxide fine particles such as ATO having a primary particle diameter of 3 nm to 30 nm are dispersed in an organic compound, and in which the metal oxide fine particles are arranged in the organic compound in a chain shape or a chain shape having branched chains. As a coating material for producing such a coating film, a coating material is disclosed, which contains metal oxide particles with a primary particle diameter of 3 nm to 30 nm, micellar particles or emulsion particles containing at least one type selected from the group consisting of acryloyl group, methacryloyl group, allyl group, and acyl group, and having an average particle diameter of from 10 nm to 10 m, and a solvent.

Furthermore, in Japanese Patent Laid-Open No. 2022-154143, a method is proposed in which ATO particles are made into chain-shaped particle clusters in a dispersion liquid. It is disclosed that such a method makes it easy for ATO particles to form a conductive path even in a coating film, resulting in an ATO dispersion liquid with which high conductivity can be obtained.

### SUMMARY

At least one aspect of the present disclosure is aimed at providing a dispersion liquid of conductive particles that can form a highly conductive film while stably maintaining the dispersion state of the conductive particles for a long period of time. In addition, at least one aspect of the present disclosure is aimed at providing a coating material for forming a resin film that can stably form a highly conductive resin film.

Furthermore, at least one aspect of the present disclosure is aimed at providing a resin film having high conductivity. Furthermore, at least one aspect of the present disclosure is aimed at providing a member having a highly conductive surface.

According to at least one aspect of the present disclosure, a dispersion liquid comprising antimony-containing tin oxide particles, an acidic compound, a basic compound, and a dispersion medium, wherein the basic compound has a molecular weight of 180 to 500 and is at least one compound selected from the group consisting of secondary amines and tertiary amines represented by a following formula (1), the dispersion liquid has a pH higher than an isoelectric point of the antimony-containing tin oxide particles, and the pH of the dispersion liquid assumes a value closer to the isoelectric point during a process of evaporating the dispersion medium from the dispersion liquid can be provided.

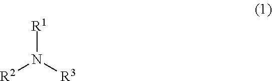

In formula (1), R¹ and R² each independently represent an aliphatic hydrocarbon group, and R³ represents a hydrogen atom or an aliphatic hydrocarbon group.

In addition, according to at least one aspect of the present disclosure, a coating material for forming a resin film comprising a resin, the coating material comprising: at least one selected from the group consisting of the resin and a precursor of the resin, antimony-containing tin oxide particles, an acidic compound, a basic compound, and an organic solvent, wherein the basic compound has a molecular weight of 180 to 500 and is at least one compound selected from the group consisting of secondary amines and tertiary amines represented by a following formula (1), the coating material has a pH higher than an isoelectric point of the antimony-containing tin oxide particles, and the pH of the coating material assumes a value closer to the isoelectric point during a process of evaporating the dispersion medium from the coating material, and the organic solvent is capable of dissolving at least a part of the resin and the precursor of the resin can be provided:

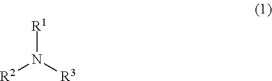

In formula (1), R¹ and R² each independently represent an aliphatic hydrocarbon group, and R³ represents a hydrogen atom or an aliphatic hydrocarbon group.

Furthermore, according to at least one aspect of the present disclosure, a resin film comprising a resin, the resin film being a cured product of a coating film of the above-mentioned coating material according can be provided. Furthermore, according to at least one aspect of the present disclosure, a member comprising a base material, and a resin film comprising a resin on a surface of the base material, wherein the resin film is a cured product of a coating film of the above-mentioned coating material.

Features of the present disclosure will become apparent from the following description of embodiments with reference to the attached drawings.

### BRIEF DESCRIPTION OF THE DRAWINGS

FIGS. 1A to 1C are explanatory diagrams of the assumed mechanism of the effect exhibited by the coating material for forming a resin film according to the present disclosure.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. Furthermore, in the present disclosure, the unit of surface resistivity (LOG Ω/□) means a logarithmic notation of (Ω/square).

The present inventors have confirmed that the dispersion liquid described in Japanese Patent Laid-Open No. 2005-187580 has excellent dispersibility of ATO particles and that the dispersion state of the ATO particles is unlikely to change even after long-term storage. However, when the dispersion liquid is mixed with a solution of a resin or a resin precursor to prepare a coating material, the resin film formed using this coating material has insufficient conductivity. This tendency is particularly noticeable when the content of ATO particles in the coating material is reduced to increase the transparency of the resin film.

The reason why the conductivity of the resin film is insufficient is presumed to be as follows. When electronically conductive particles such as ATO particles are used to impart conductivity, it is necessary to form a conductive path through which electrons flow by aggregating the particles in the coating film. However, it is believed that the resin film formed from the coating material prepared using a dispersion liquid in which ATO particles are highly dispersed does not exhibit sufficient conductivity because it is difficult to sufficiently develop the conductive path created by the ATO particles in the resin film.

Meanwhile, in the techniques disclosed in Japanese Patent Laid-Open No. 2007-211155 and Japanese Patent Laid-Open No. 2022-154143, the ATO particles are chain-like aggregated or clustered in the coating film or dispersion liquid, so that the coating film can be made conductive even with a small amount of the compounded material. However, when the ATO particles are aggregated in the dispersion liquid, the average particle diameter of the ATO particles increases. The present inventors recognized that the aggregated lumps of particles are likely to settle and the dispersion stability is low, which may lead to a decrease in the pot life of the dispersion liquid.

Therefore, the present inventors have conducted extensive research to obtain a dispersion liquid of ATO particles that can form a highly conductive film while stably maintaining the dispersion state of the conductive particles for a long period of time.

As a result, it was found that a dispersion liquid containing ATO particles, an acidic compound, a basic compound, and a dispersion medium, wherein the basic compound has a molecular weight of 180 to 500 and is at least one compound selected from the group consisting of secondary amines and tertiary amines represented by the following formula (1), the dispersion liquid has a pH higher than an isoelectric point of the antimony-containing tin oxide particles, and the pH of the dispersion liquid becomes closer to the isoelectric point in the process of evaporating the dispersion medium from the dispersion liquid, is effective in achieving the above-mentioned object.

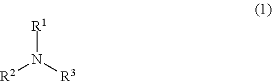

In formula (1), R¹ and R² each independently represent an aliphatic hydrocarbon group, and R³ represents a hydrogen atom or an aliphatic hydrocarbon group.

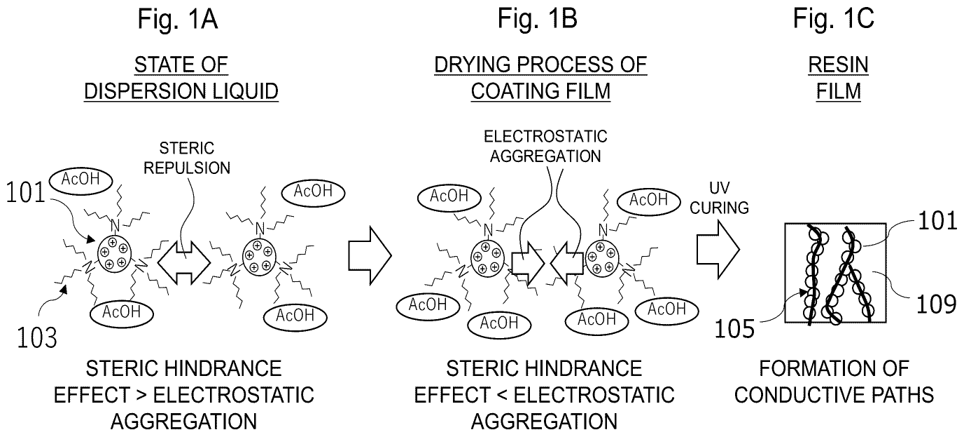

The assumed mechanism by which the dispersion liquid of ATO particles can form a highly conductive resin film while stably maintaining the dispersion state of the conductive particles for a long period of time is explained using FIGS. 1A to 1C. The mechanism exhibiting the effect described below is merely an assumption and is not limiting. In addition, in FIGS. 1A and 1B, “AcOH” represents acetic acid as an example of an acidic compound in the dispersion liquid.

FIG. 1A is a schematic diagram showing the state of ATO particles 101 in the state of dispersion liquid of the ATO particles according to one aspect of the present disclosure. In this state of dispersion liquid, the ATO particles are prevented from approaching each other by steric repulsion action (steric hindrance) of a basic compound 103 bonded or adsorbed to the surface of the ATO particles 101. Therefore, in the dispersion liquid, the aggregation of the ATO particles is unlikely to occur.

FIG. 1B is a schematic diagram showing the state of ATO particles in a coating film of a coating material for forming a resin film, which is created using the dispersion liquid, during the drying process of the coating film. In the drying process of the coating film, the concentration of the acidic compound in the coating film increases as the organic solvent evaporates from the coating film of the coating material, and the pH shifts to the acidic side. Here, since the dispersion liquid has a pH higher than the isoelectric point of the ATO particles, the zeta potential of the ATO particles in the coating film also shifts toward 0 mV (isoelectric point) as the pH shifts toward the acidic side. As a result, the electrostatic aggregation force between the ATO particles becomes stronger than the steric hindrance caused by the basic compound. The ATO particles then aggregate with each other in the coating film, forming conductive paths of the ATO particles in the coating film.

Then, the conductive paths of the ATO particles are fixed by a surrounding matrix resin 109 as the coating film dries and hardens, thereby forming a resin film that exhibits high conductivity due to the conductive paths 105 of the ATO particles (FIG. 1C). The size of the ATO particles in FIGS. 1A and 1B and the size of the ATO particles in FIG. 1C are not unified for the sake of convenience.

The dispersion liquid will be described in detail below for each configuration.

The dispersion liquid can be obtained by mixing antimony-containing tin oxide (ATO) particles, an acidic compound, a basic compound, and a dispersion medium, and dispersing the mixture in a dispersion device. That is, the manufacturing method of the dispersion liquid includes, for example, a mixing step of mixing antimony-containing tin oxide (ATO) particles, an acidic compound, a basic compound, and a dispersion medium, and a dispersion step of dispersing the mixture obtained in the mixing step in a dispersion device.

The dispersion method is not particularly limited, and it is possible to use, for example, a micronization device such as a media mill such as a ball mill, a bead mill, or a side grinder, a high-pressure homogenizer, or an ultrasonic disperser, which can highly disperse inorganic particles by a wet method.

### [Antimony-Containing Tin Oxide Particles]

The dispersion liquid contains antimony-containing tin oxide (ATO) particles. Antimony-containing tin oxide is tin oxide particles containing a small amount of an antimony compound. As such ATO particles, those generally available commercially as antimony-doped tin oxide can be used. The isoelectric point of the ATO particles is not particularly limited, and can be, for example, 2.0 to 4.0, 2.0 to 3.5, or 2.2 to 3.1.

Compared to zinc oxide-based conductive particles (e.g., aluminum-doped zinc oxide etc.), ATO particles have a high conductivity of the particles themselves and are suitable as a raw material for dispersion liquids. Zinc oxide is naturally produced as zincite and is a rare mineral that is only produced from a limited number of mines on Earth. Meanwhile, cassiterite, which is the raw material for tin oxide, has the advantage that a supply chain can be easily ensured because cassiterite is produced from mines in a large number of countries.

In addition, transparent conductive particles such as indium-containing tin oxide (ITO) particles have an even higher conductivity than ATO particles and are suitable as a raw material for transparent electrode films etc. However, indium compounds are more expensive than antimony compounds, and the material cost is higher than when ATO particles are used. In addition, ATO particles have also the ability to absorb wavelengths in the ultraviolet and infrared regions, so they are highly versatile as electrical and optical functional materials. As described above, due to low cost and low geopolitical risk, ATO particles are in high demand in the market as a raw material for dispersion liquids.

The average particle diameter of ATO particles is preferably about 1 nm to 1500 nm, more preferably 100 nm to 1000 nm. By having the average particle diameter of ATO particles in the above range, the ATO particles can be easily dispersed in a dispersion liquid, and a coating film with high transparency can be obtained. The average particle diameter of ATO particles is measured using a cumulant method, as described below.

A method for producing ATO particles is not particularly limited, and examples thereof include a method of coprecipitation and calcination using a hydrolyzable tin compound and a hydrolyzable antimony compound as raw materials. In this method, tin and antimony compounds are simultaneously hydrolyzed in the same solution to coprecipitate hydrated oxides of tin and antimony to obtain a coprecipitate. Then, salts adhering to the coprecipitate are removed by washing, and the coprecipitate is calcined at 400° C. or higher to obtain ATO particles.

When ATO particles are used as a transparent conductive material, in order to obtain high transparency and sufficient conductivity, the content of antimony oxide in the ATO particles is preferably 1 part by mass to 30 parts by mass, more preferably 5 parts by mass to 15 parts by mass, per 100 parts by mass of tin oxide.

Also, the particle surface can be treated with an organosilicon compound or the like with the object of improving the compatibility between the particles and the solvent, so long as the conductivity of the ATO particles is not impaired.

The content of ATO particles in the dispersion liquid is preferably 5% by mass to 50% by mass, more preferably 10% by mass to 40% by mass, and even more preferably 20% by mass to 35% by mass.

The dispersion liquid is mixed with a binder resin such as an acrylic resin or a precursor thereof (monomer, oligomer, etc.) to obtain a coating material for forming a resin film, and the resin coating material is formed on a freely selected base material, making it easy to manufacture a resin film having conductivity. Where there are few ATO particles in the resin film, it is difficult to form a conductive path, making it difficult to obtain sufficient conductivity. Therefore, the content ratio of ATO particles in the dispersion liquid is preferably 5% by mass or more.

Furthermore, where the concentration of ATO particles in the dispersion liquid is 50% by mass or less, the particle concentration in the dispersion is low, so that the particles are less likely to aggregate, and the pot life of the dispersion liquid is likely to be longer.

### [Basic Compound]

The dispersion liquid contains a basic compound. The basic compound has a molecular weight of 180 to 500 and is at least one compound selected from the group consisting of secondary amines and tertiary amines represented by the following formula (1).

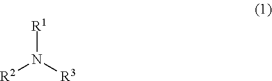

In formula (1), R¹ and R² each independently represent an aliphatic hydrocarbon group (preferably an alkyl group having 1 to 23 carbon atoms, more preferably 3 to 23 carbon atoms, even more preferably 6 to 23 carbon atoms, and particularly preferably 7 to 17 carbon atoms), and R³ represents a hydrogen atom or an aliphatic hydrocarbon group (preferably an alkyl group having 1 to 23 carbon atoms, more preferably 3 to 23 carbon atoms, even more preferably 6 to 23 carbon atoms, and particularly preferably 7 to 17 carbon atoms).

Such basic compounds are not particularly limited, and examples thereof include secondary amines such as di-n-heptylamine, dicycloheptylamine, di-n-octylamine, dicyclooctylamine, di-n-nonylamine, di-n-decylamine, di-n-undecylamine, di-n-dodecylamine, di-n-tridecylamine, di-n-tetradecylamine, di-n-pentadecylamine, di-n-hexadecylamine, and di-n-heptadecylamine.

Further examples include tertiary amines such as tri-n-butylamine, tri-n-pentylamine, tricyclopentylamine, tri-n-hexylamine, tricyclohexylamine, tri-n-heptylamine, tricycloheptylamine, tri-n-octylamine, tri-n-nonylamine, tri-n-decylamine, tri-n-undecylamine, dimethyl-n-undecylamine, dimethyl-n-dodecylamine, dimethyl-n-tridecylamine, dimethyl-n-octadecylamine, dimethyl-n-hexadecylamine, dimethyl-n-heptadecylamine, and dimethyl-n-octadecylamine. The basic compound is preferably a tertiary amine. In particular, tri-n-octylamine, tri-n-butylamine, tri-n-hexylamine, dimethyl-n-octadecylamine, and tri-n-undecylamine are suitable from the viewpoints of the pot life of the dispersion liquid and the aggregation of the conductive particles in the coating film, i.e., the ease of forming a conductive path.

One type of basic compound may be used alone, or a plurality of types can be used in combination.

By including the basic compound in the dispersion liquid, the dispersion stability of the ATO particles in the dispersion liquid can be improved, and the pot life of the dispersion liquid can be extended.

The reason why the dispersion stability of the ATO particles in the dispersion liquid is improved by including the basic compound is thought to be as follows. That is, it is thought that this is because the amine compound is bonded to the surface of the ATO particles, and the aliphatic hydrocarbon groups of the amine compound cause a steric repulsion (steric hindrance) between the ATO particles. The greater the number of aliphatic hydrocarbon groups, the more the dispersion stabilization by steric hindrance can be improved. Therefore, the basic compound is preferably at least one selected from the group consisting of secondary amines and tertiary amines.

The longer the aliphatic hydrocarbon group, the more likely it is that dispersion stabilization by steric hindrance will occur. Therefore, it is thought that the dispersion stabilization is more likely to occur with the larger molecular weight of the aliphatic hydrocarbon group. Therefore, in order to perform sufficient dispersion stabilization of ATO in the dispersion liquid, it is effective for the molecular weight to be at least 180 or more. When the molecular weight of the amine is 180 or more, sufficient steric hindrance is generated in the dispersion liquid, and it is possible to prevent the aggregation and sedimentation of the ATO particles in the dispersion liquid. As a result, the pot life of the dispersion liquid is improved.

Furthermore, when the molecular weight of the basic compound is 500 or less, the electrostatic aggregation force acting on the ATO particles due to the increase in pH in the coating film during the process of drying the coating film of the coating material for forming the resin film can be made stronger than the steric repulsive force caused by the basic compound. Therefore, the formation of conductive paths by the ATO particles during the drying process of the coating film is promoted, and the conductivity of the resin film can be more easily expressed. In addition, the surface of the ATO particles can be prevented from being covered with aliphatic hydrocarbon groups, which would otherwise occur if the aliphatic hydrocarbon group of the basic compound were too long. As a result, the conductivity of the ATO particles themselves is less likely to decrease. This contributes to the formation of a resin film having conductivity.

In view of the above, the molecular weight of the basic compound is preferably 180 to 500, particularly preferably 200 to 500, and even more preferably 250 to 450.

The content of the basic compound in the dispersion liquid is not particularly limited as long as it is within a range in which the above-mentioned effects are exhibited, but is preferably 0.05 parts by mass to 5.00 parts by mass, more preferably 0.10 parts by mass to 3.00 parts by mass, even more preferably 0.20 parts by mass to 1.00 part by mass, and especially preferably 0.25 parts by mass to 1.00 part by mass, relative to 100 parts by mass of the ATO particles. Within these ranges, a sufficient dispersion stabilization effect is produced on the ATO particles, and the aggregation action during the drying process of the coating film is stronger than the steric repulsion action, making it easier to control the aggregation of the ATO particles and easier for the ATO particles to form a conductive path. In other words, this contributes to the formation of a resin film having conductivity. In addition, the dispersion liquid is more likely to have a pH higher than the isoelectric point of the ATO particles.

### [Acidic Compound]

As described above, the zeta potential of the particles in the dispersion liquid is affected by the pH of the dispersion liquid. In addition, the pH of the dispersion liquid is controlled so that the pH of the coating film during the drying process of the coating film of the dispersion liquid approaches the isoelectric point of the ATO particles. For this reason, the dispersion liquid contains an acidic compound. By including an acidic compound in the dispersion liquid, the pH of the dispersion liquid can be made closer to the isoelectric point of the ATO particles during the process of evaporating the dispersion medium from the dispersion liquid.

There is no particular limitation on the acidic compound as long as the pH of the dispersion liquid shifts to the acidic side during the process in which the dispersion medium contained in the dispersion liquid evaporates. For example, organic acids such as carboxylic acids such as acetic acid, malic acid, lactic acid, and succinic acid, sulfonic acids, and phosphoric acid esters, and inorganic acids such as hydrochloric acid, sulfuric acid, nitric acid, and phosphoric acid can be used.

When the dispersion liquid is mixed with a resin such as an acrylic resin or a urethane resin to form a coating material for forming a resin film, organic acids are preferred from the viewpoint of compatibility, low molecular weight compounds such as acetic acid and malic acid are more preferred, and weak acids are even more preferred. One type of acidic compound may be used alone, or a plurality of types may be used in combination.

The content of the acidic compound in the dispersion liquid is, relative to 100 parts by mass of the ATO particles, preferably 0.10 parts by mass to 5.00 parts by mass, more preferably 0.10 parts by mass to 3.00 parts by mass, even more preferably 0.10 parts by mass to 2.00 parts by mass, still more preferably 0.20 parts by mass to 2.00 parts by mass, particularly preferably 0.40 parts by mass to 2.00 parts by mass, and especially preferably 0.50 parts by mass to 2.00 parts by mass.

Within these ranges, in the state of the dispersion liquid, the pH of the dispersion liquid is far from the isoelectric point of the ATO particles, so that the aggregation action is likely to be weak. Therefore, the steric repulsion action of the amine compound prevails, making it easier to maintain the highly dispersed state of the ATO particles. In addition, in the process of evaporating the dispersion medium from the dispersion liquid, the pH is likely to shift to an acidic side. Accordingly, the zeta potential of the ATO particles in the dispersion liquid is also likely to shift toward 0 mV (isoelectric point). As a result, the aggregation effect tends to prevail over the steric repulsion effect, making it easier to control the aggregation of the ATO particles, and making it easier for the ATO particles to form a conductive path.

### [Dispersion Medium]

The dispersion liquid contains a dispersion medium. The dispersion medium is not particularly limited as long as it is one that is generally used in coating materials, but it is preferably an organic solvent. For example, aliphatic alcohols such as methyl alcohol, ethyl alcohol, isopropyl alcohol, and isobutyl alcohol, aromatic alcohols such as benzyl alcohol, and ketones such as methyl isobutyl ketone, methyl ethyl ketone, diisobutyl ketone, and cyclohexanone can be used. One type of these organic solvents may be used alone, or two or more types may be used in combination. In addition, even when the coating film of the coating material for forming a resin film is dried in a room temperature environment such as a temperature of 23° C., it is preferable to include a volatile organic solvent such as isopropyl alcohol or methyl ethyl ketone in the dispersion medium, since this makes it easier to increase the pH in the coating film.

The content ratio of the dispersion medium in the dispersion liquid is not particularly limited and may be set, as appropriate, based on the viscosity of the dispersion liquid, etc., but is preferably 20% by mass to 90% by mass, and more preferably 30% by mass to 90% by mass.

The dispersion liquid and water (ion-exchanged water) are mixed in a mass ratio of 1:1, and the pH of the resulting diluted solution is denoted by pH1. The diluted solution is allowed to stand in an open system at 25° C., and the pH when the content of the ATO particles in the diluted solution becomes 50% by mass is denoted by pH2, and the pH when the content ratio of the ATO particles becomes 80% by mass is denoted by pH3. The value of pH1 is not particularly limited as long as it is higher than the isoelectric point of the antimony-containing tin oxide particles, and can be, for example, 4.0 to 6.2, and preferably 4.0 to 5.9.

Furthermore, the value of pH2 preferably satisfies pH1>pH2, and can be, for example, 2.0 to 5.5, and is preferably 2.0 to 4.0, more preferably 2.0 to 3.2, and even more preferably 2.0 to 3.0.

In addition, the value of pH3 preferably satisfies pH1>pH3, and can be, for example, 2.0 to 4.0, preferably 2.0 to 3.5, and more preferably 2.0 to 3.1.

By setting the values of pH2 and pH3 within the above ranges, the pH of the coating material for forming a resin film becomes closer to the isoelectric point of the ATO particles in the process of evaporating the dispersion medium, so that the ATO particles tend to aggregate and form a conductive path in the state of the resin film formed by curing the coating material for forming a resin film.

The values of pH1, pH2, and pH3 can be adjusted by changing the type and content of the acidic compound and basic compound.

### [Coating Material for Forming Resin Film]

The coating material for forming a resin film according to at least one aspect of the present disclosure is for forming a resin film containing a resin and includes at least one selected from the group consisting of the resin and a precursor of the resin, antimony-containing tin oxide particles, an acidic compound, a basic compound, and an organic solvent. The basic compound has a molecular weight of 180 to 500 and is at least one compound selected from the group consisting of secondary amines and tertiary amines represented by the following formula (1). The coating material has a pH higher than an isoelectric point of the antimony-containing tin oxide particles, and the pH of the coating material assumes a value closer to the isoelectric point during a process in which the organic solvent evaporates from the coating material. The organic solvent is capable of dissolving at least a part of the resin and the precursor of the resin.

By using such a coating material for forming a resin film, a highly conductive resin film can be stably formed. This is considered to be due to the assumed mechanism explained above using FIGS. 1A to 1C.

The antimony-containing tin oxide particles, acidic compounds, and basic compounds described in the respective sections above can be used. The pH of the coating material can be the same as, for example, the pH of the dispersion liquid.

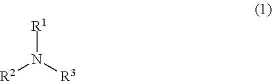

In formula (1), R¹ and R² each independently represent an aliphatic hydrocarbon group, and R³ represents a hydrogen atom or an aliphatic hydrocarbon group.

The coating material for forming a resin film contains at least one selected from the group consisting of resins and precursors of the resins.

The resin is not particularly limited, and thermoplastic resins, thermosetting resins, ionizing radiation curable resins, etc. can be used. Ionizing radiation curable resins include resins that can be cured with ultraviolet rays or electron beams, such as ultraviolet curable resins and electron beam curable resins, such as acrylic resins. Acrylic resins is a general term for acrylic resins and methacrylic resins.

The resin precursor is not particularly limited, and for example, monomers, oligomers, and polymers of thermosetting resins and ionizing radiation curable resins can be used as resin precursors. When a resin precursor is used, for example, by including a polymerization initiator such as a photopolymerization initiator in the coating material for forming a resin film, the resin precursor can be polymerized by heat, ultraviolet light, electron beams, etc., and cured to form a resin. For example, precursors of acrylic resins include monomers and oligomers that can form acrylic resins. The monomers and oligomers are not particularly limited, and known ones can be used.

The content ratio of at least one selected from the group consisting of resins and precursors of the resins in the coating material for forming a resin film is not particularly limited, but is preferably 5.0% by mass to 30.0% by mass, and more preferably 5.0% by mass to 20.0% by mass, for example.

The acrylic resin is preferably a polymer of at least one selected from the group consisting of pentaerythritol tri(meth)acrylate, pentaerythritol tetra(meth)acrylate, ditrimethylolpropane tetra(meth)acrylate, dipentaerythritol hexa(meth)acrylate, alkyl (meth)acrylates, benzyl (meth)acrylate, phenyl (meth)acrylate, ethylene glycol di(meth)acrylate, and bisphenol A di(meth)acrylate.

The acrylic resin is more preferably a polymer of at least one selected from the group consisting of pentaerythritol tri(meth)acrylate and pentaerythritol tetra(meth)acrylate. The acrylic resin is more preferably a polymer of pentaerythritol triacrylate and pentaerythritol tetraacrylate.

Examples of thermosetting resins include urethane resin, melamine resin, phenolic resin, and unsaturated polyester resin. Examples of the thermoplastic resin include polyamide resina, polyimide resina, polyvinyl chloride resin, etc.

As the resin, one type of the above-mentioned resins may be used alone, or a plurality of types may be used in combination.

The solid content concentration of the coating material for forming a resin film may be set, as appropriate, in consideration of the ease of application, the film thickness when formed into a coating film, the electrical conductivity, etc. For example, in the coating material for forming a resin film, the content of the ATO particles may be 3.0 parts by mass to 50.0 parts by mass, preferably 3.0 parts by mass to 40.0 parts by mass, and more preferably 3.0 parts by mass to 35.0 parts by mass, per 100 parts by mass of at least one selected from the group consisting of resins and precursors of the resins in the coating material for forming a resin film. The abovementioned ranges are preferred because the content of the ATO particles in the resin film can be reduced, and the resin film can be imparted with excellent electrical conductivity while maintaining transparency.

Examples of the organic solvent contained in the coating material for forming a resin film may include organic solvents capable of dissolving at least a part of the above-mentioned resin or at least a part of the precursor of the above-mentioned resin. For example, the organic solvents listed in the above section related to the dispersion medium may be used.

Furthermore, other additives can be blended into the coating material for forming a resin film as necessary to the extent that the effect of the present disclosure is not impaired. For example, it is possible to add a curing initiator, a leveling agent, an antifoaming agent, a lubricant, and other organic compounds and inorganic compounds.

A method for manufacturing the coating material for forming a resin film can be carried out using a known stirring method. For example, the coating material can be manufactured through a mixing step for mixing the dispersion liquid according to the present disclosure with at least one selected from the group consisting of resins and precursors of the resins, and, if necessary, other organic solvents and other additives, and a homogenization step for uniformly mixing the mixture obtained in the mixing step with a dispersing device such as a mechanical stirrer or a paint material shaker that shakes the coating material at high speed.

### [Resin Film Containing ATO Particles]

The resin film includes a cured product of the coating material for forming a resin film according to the present disclosure. Specifically, the coating material for forming a resin film is uniformly coated on the surface of the base material by a known film forming method, such as gravure coating, wire bar coating, spray coating, dip coating, slit coating, etc., to form a coating film. This coating film is dried, and if necessary, a curing process is performed for the resin precursor to cure the coating film and form a resin film. Examples of the drying and necessary curing processes include heating and ultraviolet irradiation. As described above, the dispersion liquid according to the present disclosure has excellent dispersibility of ATO particles and also has excellent aggregation property of ATO during the drying process. Therefore, it is possible to impart high conductivity to the resin film without increasing the content of ATO particles in the coating material. As a result, it is possible to impart high conductivity and high transparency to visible light to the resin film according to the present disclosure. Therefore, the resin film according to the present disclosure can be used extremely suitably for applications such as conductive films that require transparency, specifically, transparent electrodes and the like.

### [Member]

The member of the present disclosure has a base material and a resin film on the surface of the base material, and includes a cured product of the coating film of the coating material for forming the resin film of the present disclosure. By making such a member, a member having a highly conductive surface can be obtained.

The material used for the base material is not particularly limited, and plastics, glass, metals, ceramics, etc. can be used.

### EXAMPLES

The present disclosure will be described in more detail below using examples. The aspects of the present disclosure are not limited to the following examples.

First, methods for evaluating the physical properties of a dispersion liquid, a coating material for forming a resin film, and a cured product of the coating film of the coating material for forming a resin film will be described.

### <Average Particle Diameter of ATO Particles>

The average particle diameter of ATO particles in the dispersion liquid was measured using a particle diameter distribution analyzer (FPAR-1000, manufactured by Otsuka Electronics Co., Ltd.) that calculates the average particle diameter by dynamic light scattering. The measurement was performed at a temperature of 23° C., and the average particle diameter was calculated by the cumulant method using, as the measurement conditions, a refractive index of 1.3749 and a viscosity of 1.77 mPa·s, with reference to the values for isopropyl alcohol as the dispersion medium. The dispersion liquid was not diluted during measurement, and the measurement was performed with the measurement conditions of particle size distribution meter set to a concentrated mode.

### <Measurement of pH of Dispersion Liquid>

The pH (pH1) of the dispersion liquid defined in the present invention was measured by the following method. That is, the dispersion liquid and water (ion-exchanged water) were mixed in a mass ratio of 1:1, and the mixture was stirred with a magnetic stirrer for 30 min to prepare a diluted solution. This diluted solution was measured at 25° C. with a pH meter (LAQUATWIN, manufactured by HORIBA).

Further, the diluted solution was allowed to stand in an open system at 25° C., and the pH was measured when the content of ATO particles in the diluted solution reached 50% by mass (pH2) and 80% by mass (pH3).

### <Measurement of Isoelectric Point of ATO Particles>

The isoelectric point of ATO particles refers to the pH value when the surface zeta potential becomes zero. In the present disclosure, the isoelectric point of the ATO particles used to prepare the dispersion liquid was measured by the following method.

A dispersion liquid was prepared by dispersing ATO particles in isopropyl alcohol (manufactured by Kishida Chemical Co., Ltd.) at a concentration of 196.4 g/L, and the pH of the dispersion liquid was adjusted to pH=1, pH=2, pH=3, . . . , pH=6 using an aqueous solution of acetic acid to prepare six types of samples for isoelectric point measurement. The pH of the samples was measured by the above-mentioned method. Each sample for isoelectric point measurement was measured using a zeta potential/particle size distribution measurement system (product name: ELSZ-1000; manufactured by Otsuka Electronics Co., Ltd.). The measurement conditions were an applied voltage of 40 V and 20 cumulative times. The analysis was performed using the Huckel method. The isoelectric point was determined by the pH at which the zeta potential became ±0 mV when two points on either side of the zeta potential of ±0 mV were connected with a straight line. The isoelectric point of ATO used as the raw material in this example, determined by the above method, was pH=2.2 to 3.1.

### <Surface Resistivity of Resin Film>

The surface resistivity of the resin film was measured using a resistivity meter (product name: Hiresta UP MCP-HT450, manufactured by Mitsubishi Chemical Analytech Co., Ltd.) in accordance with Japan Industrial Standard (JIS) K 6911. To measure the surface resistivity of the resin film, a PEN film having a resin film on the surface thereof that was prepared by the method described below was used. The surface resistivity of the resin film was measured by bringing a UR100 probe into contact with the resin film on the surface of the PEN film in an environment of 23° C. temperature and 50% relative humidity, applying a voltage of 100 V, and calculating the measured value for a measurement time of 10 sec.

### <Transparency of Resin Film>

To evaluate the transparency of the resin film, the haze value of the PEN film having a resin film on the surface that was produced by the method described below was measured with a haze meter (TC-H3DPK-MKII, manufactured by Tokyo Denshoku Co., Ltd.).

### Example 1

### (Preparation of Dispersion Liquid 1)

A total of 12.0 g of antimony-containing tin oxide particles (product name: SN-100P, manufactured by Ishihara Sangyo Kaisha, Ltd., isoelectric point: 2.2-3.1), 0.12 g of acetic acid (manufactured by Kishida Chemical Co., Ltd.) as an acidic compound, 0.03 g of trioctylamine (manufactured by Kishida Chemical Co., Ltd.) as a basic compound, and 48.0 g of isopropyl alcohol (manufactured by Kishida Chemical Co., Ltd.) as a solvent were weighed and placed in a 250 mL zirconia container. Furthermore, 108.3 g of zirconia beads with a diameter of 0.5 mm were added to the container. After that, stirring was performed at 300 rpm for 2 h using a planetary ball mill (model: P-6, manufactured by Fritsch Japan Co., Ltd.). The beads were then removed by mesh filtration to obtain dispersion liquid 1 with a solid content concentration of the ATO particles (i.e., the content ratio of the ATO particles in the dispersion liquid) of 20% by mass.

The average particle diameter of the ATO particles contained in dispersion liquid 1 was measured to be 528.1 nm. Further, dispersion liquid 1 was stored in a sealed environment at room temperature of 25° C., and the average particle diameter of the ATO particles was measured using the same method one month after preparation. The result was 541.7 nm. The rate of change in the average particle diameter over one month was 2.5%, and it was found that the ATO particles were stably dispersed in the dispersion liquid over time.

Furthermore, the pH (pH1) of dispersion liquid 1 immediately after preparation was 4.7. The dispersion liquid was allowed to stand in an open system, and the pH was measured when the ATO solid content concentration in the dispersion liquid reached 50% by mass and 80% by mass. The results were pH2=2.6 and pH3=2.2, respectively.

### (Preparation of Coating Material for Forming Resin Film Containing Dispersion Liquid 1)

A total of 15.0 g of dispersion liquid 1 was weighed out, and 10.0 g of pentaerythritol tri- and tetraacrylate (product name: Aronix M-305, manufactured by Toagosei Co., Ltd.), 0.2 g of a photopolymerization initiator (product name: Omnirad 907, manufactured by IGM Resins B.V.), and 52.8 g of methyl ethyl ketone were mixed and stirred with dispersion liquid 1 to obtain coating material 1 for forming a resin film. In the present disclosure, the expression pentaerythritol tri- and tetraacrylate refers to a mixture of pentaerythritol triacrylate and pentaerythritol tetraacrylate.

### (Preparation of Resin Film Containing Cured Product of Coating Film of Coating Material 1 for Forming Resin Film)

Coating material 1 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 1 having resin film 1 on the surface.

The surface resistivity of the obtained PEN film 1 was measured and found to be 9.77 (LOG Ω/□). Furthermore, the haze value was 0.2.

### Example 2

### (Preparation of Dispersion Liquid 2)

Dispersion liquid 2 was obtained in the same manner as in Example 1, except that the materials and contents were changed to those listed in Table 1. The average particle diameter of the ATO particles contained in this dispersion liquid 2 was measured to be 443.7 nm. Furthermore, dispersion liquid 2 was stored in a sealed environment at room temperature of 25° C., and the average particle diameter of the ATO particles was measured using the same method one month after preparation. The result was 541.9 nm. The rate of change in the average particle diameter over one month was 1.8%, and it was found that the ATO particles were stably dispersed in the dispersion liquid over time.

Furthermore, the pH (pH1) of dispersion liquid 2 immediately after preparation was 4.0. The dispersion liquid was allowed to stand in an open system, and the pH was measured when the ATO solid content concentration in the dispersion liquid reached 50% by mass and 80% by mass. The results were pH2=2.5 and pH3=2.5, respectively.

### (Preparation of Coating Material for Forming Resin Film Containing Dispersion Liquid 2)

Coating material 2 for forming a resin film was obtained in the same manner as in Example 1, except that the dispersion liquid was changed to dispersion liquid 2.

### (Preparation of Resin Film Containing Cured Product of Coating Film of Coating Material 2 for Forming Resin Film)

Coating material 2 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 2 having resin film 2 on the surface.

The surface resistivity of the obtained PEN film 2 was measured and found to be 10.34 (LOG Ω/□). Furthermore, the haze value was 0.1.

### Example 3

### (Preparation of Dispersion Liquid 3)

Dispersion liquid 3 was obtained in the same manner as in Example 1, except that the materials and contents were changed to those listed in Table 1. The average particle diameter of the ATO particles contained in this dispersion liquid 3 was measured to be 709.1 nm. Furthermore, dispersion liquid 3 was stored in a sealed environment at room temperature of 25° C., and the average particle diameter of the ATO particles was measured using the same method one month after preparation. The result was 732.3 nm. The rate of change in the average particle diameter over one month was 3.2%, and it was found that the ATO particles were stably dispersed in the dispersion liquid over time.

Furthermore, the pH (pH1) of dispersion liquid 3 immediately after preparation was 5.7. The dispersion liquid was allowed to stand in an open system, and the pH was measured when the ATO solid content concentration in the dispersion liquid reached 50% by mass and 80% by mass. The results were pH2=3.0 and pH3=2.5, respectively.

### (Preparation of Coating Material for Forming Resin Film Containing Dispersion Liquid 3)

Coating material 3 for forming a resin film was obtained in the same manner as in Example 1, except that the dispersion liquid was changed to dispersion liquid 3.

### (Preparation of Resin Film Containing Cured Product of Coating Film of Coating Material 3 for Forming Resin Film)

Coating material 3 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 3 having resin film 3 on the surface.

The surface resistivity of the obtained PEN film 3 was measured and found to be 9.22 (LOG Ω/□). Furthermore, the haze value was 0.5.

### Example 4

### (Preparation of Dispersion Liquid 4)

Dispersion liquid 4 was obtained in the same manner as in Example 1, except that the materials and contents were changed to those listed in Table 1. The average particle diameter of the ATO particles contained in this dispersion liquid 4 was measured to be 497.9 nm. Furthermore, dispersion liquid 4 was stored in a sealed environment at room temperature of 25° C., and the average particle diameter of the ATO particles was measured using the same method one month after preparation. The result was 515.1 nm. The rate of change in the average particle diameter over one month was 3.3%, and it was found that the ATO particles were stably dispersed in the dispersion liquid over time.

Furthermore, the pH (pH1) of dispersion liquid 4 immediately after preparation was 5.5. The dispersion liquid was allowed to stand in an open system, and the pH was measured when the ATO solid content concentration in the dispersion liquid reached 50% by mass and 80% by mass. The results were pH2=2.9 and pH3=2.5, respectively.

### (Preparation of Coating Material for Forming Resin Film Containing Dispersion Liquid 4)

Coating material 4 for forming a resin film was obtained in the same manner as in Example 1, except that the dispersion liquid was changed to dispersion liquid 4.

### (Preparation of Resin Film Containing Cured Product of Coating Film of Coating Material 4 for Forming Resin Film)

Coating material 4 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 4 having resin film 4 on the surface.

The surface resistivity of the obtained PEN film 4 was measured and found to be 10.15 (LOG Ω/□). Furthermore, the haze value was 0.2.

### Example 5

### (Preparation of Dispersion Liquid 5)

Dispersion liquid 5 was obtained in the same manner as in Example 1, except that the materials and contents were changed to those listed in Table 1. The average particle diameter of the ATO particles contained in this dispersion liquid 5 was measured to be 571.3 nm. Furthermore, dispersion liquid 5 was stored in a sealed environment at room temperature of 25° C., and the average particle diameter of the ATO particles was measured using the same method one month after preparation. The result was 588.1 nm. The rate of change in the average particle diameter over one month was 2.9%, and it was found that the ATO particles were stably dispersed in the dispersion liquid over time.

Furthermore, the pH (pH1) of dispersion liquid 5 immediately after preparation was 4.8. The dispersion liquid was allowed to stand in an open system, and the pH was measured when the ATO solid content concentration in the dispersion liquid reached 50% by mass and 80% by mass. The results were pH2=2.7 and pH3=2.4, respectively.

### (Preparation of Coating Material for Forming Resin Film Containing Dispersion Liquid 5)

Coating material 5 for forming a resin film was obtained in the same manner as in Example 1, except that the dispersion liquid was changed to dispersion liquid 5.

### (Preparation of Resin Film Containing Cured Product of Coating Film of Coating Material 5 for Forming Resin Film)

Coating material 5 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 5 having resin film 5 on the surface.

The surface resistivity of the obtained PEN film 5 was measured and found to be 9.41 (LOG Ω/□). Furthermore, the haze value was 0.3.

### Example 6

### (Preparation of Dispersion Liquid 6)

Dispersion liquid 6 was obtained in the same manner as in Example 1, except that the materials and contents were changed to those listed in Table 1. The average particle diameter of the ATO particles contained in this dispersion liquid 6 was measured to be 557.4 nm. Furthermore, dispersion liquid 6 was stored in a sealed environment at room temperature of 25° C., and the average particle diameter of the ATO particles was measured using the same method one month after preparation. The result was 575.2 nm. The rate of change in the average particle diameter over one month was 3.1%, and it was found that the ATO particles were stably dispersed in the dispersion liquid over time.

Furthermore, the pH (pH1) of dispersion liquid 6 immediately after preparation was 4.4. The dispersion liquid was allowed to stand in an open system, and the pH was measured when the ATO solid content concentration in the dispersion liquid reached 50% by mass and 80% by mass. The results were pH2=2.6 and pH3=2.3, respectively.

### (Preparation of Coating Material for Forming Resin Film Containing Dispersion Liquid 6)

Coating material 6 for forming a resin film was obtained in the same manner as in Example 1, except that the dispersion liquid was changed to dispersion liquid 6.

### (Preparation of Resin Film Containing Cured Product of Coating Film of Coating Material 6 for Forming Resin Film)

Coating material 6 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 6 having resin film 6 on the surface.

The surface resistivity of the obtained PEN film 6 was measured and found to be 9.58 (LOG Ω/□). Furthermore, the haze value was 0.3.

### Example 7

### (Preparation of Dispersion Liquid 7)

Dispersion liquid 7 was obtained in the same manner as in Example 1, except that the materials and contents were changed to those listed in Table 1. The average particle diameter of the ATO particles contained in this dispersion liquid 7 was measured to be 569.8 nm. Furthermore, dispersion liquid 7 was stored in a sealed environment at room temperature of 25° C., and the average particle diameter of the ATO particles was measured using the same method one month after preparation. The result was 590.4 nm. The rate of change in the average particle diameter over one month was 3.5%, and it was found that the ATO particles were stably dispersed in the dispersion liquid over time.

Furthermore, the pH (pH1) of dispersion liquid 7 immediately after preparation was 4.7. The dispersion liquid was allowed to stand in an open system, and the pH was measured when the ATO solid content concentration in the dispersion liquid reached 50% by mass and 80% by mass. The results were pH2=2.5 and pH3=2.2, respectively.

### (Preparation of Coating Material for Forming Resin Film Containing Dispersion Liquid 7)

Coating material 7 for forming a resin film was obtained in the same manner as in Example 1, except that the dispersion liquid was changed to dispersion liquid 7.

### (Preparation of Resin Film Containing Cured Product of Coating Film of Coating Material 7 for Forming Resin Film)

Coating material 7 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 7 having resin film 7 on the surface.

The surface resistivity of the obtained PEN film 7 was measured and found to be 9.61 (LOG Ω/□). Furthermore, the haze value was 0.4.

### Example 8

### (Preparation of Dispersion Liquid 8)

Dispersion liquid 8 was obtained in the same manner as in Example 1, except that the materials and contents were changed to those listed in Table 1. The average particle diameter of the ATO particles contained in this dispersion liquid 8 was measured to be 446.1 nm. Furthermore, dispersion liquid 8 was stored in a sealed environment at room temperature of 25° C., and the average particle diameter of the ATO particles was measured using the same method one month after preparation. The result was 451.3 nm. The rate of change in the average particle diameter over one month was 1.2%, and it was found that the ATO particles were stably dispersed in the dispersion liquid over time.

Furthermore, the pH (pH1) of dispersion liquid 8 immediately after preparation was 5.9. The dispersion liquid was allowed to stand in an open system, and the pH was measured when the ATO solid content concentration in the dispersion liquid reached 50% by mass and 80% by mass. The results were pH2=2.6 and pH3=2.3, respectively.

### (Preparation of Coating Material for Forming Resin Film Containing Dispersion Liquid 8)

Coating material 8 for forming a resin film was obtained in the same manner as in Example 1, except that the dispersion liquid was changed to dispersion liquid 8.

### (Preparation of Resin Film Containing Cured Product of Coating Film of Coating Material 8 for Forming Resin Film)

Coating material 8 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 8 having resin film 8 on the surface.

The surface resistivity of the obtained PEN film 8 was measured and found to be 10.84 (LOG Ω/□). Furthermore, the haze value was 0.2.

### Example 9

### (Preparation of Dispersion Liquid 9)

Dispersion liquid 9 was obtained in the same manner as in Example 1, except that the materials and contents were changed to those listed in Table 1. The average particle diameter of the ATO particles contained in this dispersion liquid 9 was measured to be 459.5 nm. Furthermore, dispersion liquid 9 was stored in a sealed environment at room temperature of 25° C., and the average particle diameter of the ATO particles was measured using the same method one month after preparation. The result was 469.9 nm. The rate of change in the average particle diameter over one month was 2.2%, and it was found that the ATO particles were stably dispersed in the dispersion liquid over time.

Furthermore, the pH (pH1) of dispersion liquid 9 immediately after preparation was 5.9. The dispersion liquid was allowed to stand in an open system, and the pH was measured when the ATO solid content concentration in the dispersion liquid reached 50% by mass and 80% by mass. The results were pH2=5.5 and pH3=3.1, respectively.

### (Preparation of Coating Material for Forming Resin Film Containing Dispersion Liquid 9)

A total of 20.0 g of dispersion liquid 9 was weighed out, and 10.0 g of pentaerythritol tri- and tetraacrylate (product name: Aronix M-305, manufactured by Toagosei Co., Ltd.), 0.2 g of a photopolymerization initiator (product name: Omnirad 907, manufactured by IGM Resins B.V.), and 56.8 g of methyl ethyl ketone were mixed with dispersion liquid 9 and stirred to obtain coating material 9 for forming a resin film.

### (Preparation of Resin Film Containing Cured Product of Coating Film of Coating Material 9 for Forming Resin Film)

Coating material 9 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 9 having resin film 9 on the surface.

The surface resistivity of the obtained PEN film 9 was measured and found to be 10.99 (LOG Ω/□). Furthermore, the haze value was 0.6.

### Example 10

### (Preparation of Dispersion Liquid 10)

Dispersion liquid 10 was obtained in the same manner as in Example 1, except that the materials and contents were changed to those listed in Table 1. The average particle diameter of the ATO particles contained in this dispersion liquid 10 was measured to be 451.3 nm. Furthermore, dispersion liquid 10 was stored in a sealed environment at room temperature of 25° C., and the average particle diameter of the ATO particles was measured using the same method one month after preparation. The result was 463.3 nm. The rate of change in the average particle diameter over one month was 2.6%, and it was found that the ATO particles were stably dispersed in the dispersion liquid over time.

Furthermore, the pH (pH1) of dispersion liquid 10 immediately after preparation was 4.9. The dispersion liquid was allowed to stand in an open system, and the pH was measured when the ATO solid content concentration in the dispersion liquid reached 50% by mass and 80% by mass. The results were pH2=2.7 and pH3=2.5, respectively.

### (Preparation of Coating Material for Forming Resin Film Containing Dispersion Liquid 10)

Coating material 10 for forming a resin film was obtained in the same manner as in Example 1, except that the dispersion liquid was changed to dispersion liquid 10.

### (Preparation of Resin Film Containing Cured Product of Coating Film of Coating Material 10 for Forming Resin Film)

Coating material 10 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 10 having resin film 10 on the surface.

The surface resistivity of the obtained PEN film 10 was measured and found to be 10.48 (LOG Ω/□). Furthermore, the haze value was 0.3.

### Comparative Example 1

### (Preparation of Dispersion Liquid 11)

Dispersion liquid 11 was obtained in the same manner as in Example 1, except that the materials and contents were changed to those listed in Table 1. The average particle diameter of the ATO particles contained in this dispersion liquid 11 was measured to be 1360.4 nm. Furthermore, dispersion liquid 11 was stored in a sealed environment at room temperature of 25° C., and the average particle diameter of the ATO particles was measured using the same method one month after preparation. The result was 4435.1 nm. The rate of change in the average particle diameter over one month was 69.3%, and it was found that the ATO particles aggregated and settled over time in the dispersion liquid and the dispersion was unstable.

Furthermore, the pH (pH1) of dispersion liquid 11 immediately after preparation was 4.6. The dispersion liquid was allowed to stand in an open system, and the pH was measured when the ATO solid content concentration in the dispersion liquid reached 50% by mass and 80% by mass. The results were pH2=2.7 and pH3=2.5, respectively.

### (Preparation of Coating Material for Forming Resin Film Containing Dispersion Liquid 11)

Coating material 11 for forming a resin film was obtained in the same manner as in Example 1, except that the dispersion liquid was changed to dispersion liquid 11.

### (Preparation of Resin Film Containing Cured Product of Coating Film of Coating Material 11 for Forming Resin Film)

Coating material 11 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 11 having resin film 11 on the surface.

The surface resistivity of the obtained PEN film 11 was measured and found to be 8.94 (LOG Ω/□). Furthermore, the haze value was 2.2.

### Comparative Example 2

### (Preparation of Dispersion Liquid 12)

Dispersion liquid 12 was obtained in the same manner as in Example 1, except that the materials and contents were changed to those listed in Table 1. The average particle diameter of the ATO particles contained in this dispersion liquid 12 was measured to be 443.1 nm. Furthermore, dispersion liquid 12 was stored in a sealed environment at room temperature of 25° C., and the average particle diameter of the ATO particles was measured using the same method one month after preparation. The result was 446.1 nm. The rate of change in the average particle diameter over one month was 0.7%, and it was found that the ATO particles were stably dispersed in the dispersion liquid over time.

Furthermore, the pH (pH1) of dispersion liquid 12 immediately after preparation was 4.4. The dispersion liquid was allowed to stand in an open system, and the pH was measured when the ATO solid content concentration in the dispersion liquid reached 50% by mass and 80% by mass. The results were pH2=2.7 and pH3=2.5, respectively.

### (Preparation of Coating Material for Forming Resin Film Containing Dispersion Liquid 12)

Coating material 12 for forming a resin film was obtained in the same manner as in Example 1, except that the dispersion liquid was changed to dispersion liquid 12.

### (Preparation of Resin Film Containing Cured Product of Coating Film of Coating Material 12 for Forming Resin Film)

Coating material 12 for forming a resin film was coated on a PEN film (Teonex Q51, manufactured by Toyobo Co., Ltd.) by bar coating using a No. 16 wire bar. After that, the coating was dried for 1 min in a 23° C. environment under exhaust air. After that, the coating film was irradiated with ultraviolet light using a UV irradiator (product name: UE06/81-3, manufactured by Eye Graphics Co., Ltd.) until the accumulated light quantity reached 600 mJ/cm², and the coating film was cured to prepare PEN film 12 having resin film 12 on the surface.

The surface resistivity of the obtained PEN film 12 was measured and found to be 12.87 (LOG Ω/□). Furthermore, the haze value was 0.1.

Table 1 shows the types and contents of the conductive particles, acidic compounds, basic compounds and dispersion media contained in the dispersion liquids described in Examples 1 to 10 and Comparative Examples 1 and 2.

TABLE 1

| | | Material formulation | | | | | | |
|---|---|---|---|---|---|---|---|---|
| | | | Acidic compound | | Basic compound | | | |
| | | Conductive | | Content | | | Content | Dispersion |
| | Dispersion | particles | | (parts by | | Molecular | (parts by | medium |
| | liquid No. | Type | Type | mass) | Type | weight | mass) | Type |
| Example 1 | 1 | ATO | Acetic | 1.00 | TOA | 353.7 | 0.25 | IPA |
| | | | acid | | | | | |
| Example 2 | 2 | ATO | Acetic | 2.00 | TOA | 353.7 | 1.00 | IPA |
| | | | acid | | | | | |
| Example 3 | 3 | ATO | Acetic | 0.40 | TOA | 353.7 | 0.10 | IPA |
| | | | acid | | | | | |
| Example 4 | 4 | ATO | Malic | 1.00 | TOA | 353.7 | 0.25 | IPA |
| | | | acid | | | | | |
| Example 5 | 5 | ATO | Acetic | 1.00 | TBA | 185.4 | 0.25 | IPA |
| | | | acid | | | | | |
| Example 6 | 6 | ATO | Acetic | 1.00 | THA | 269.5 | 0.25 | IPA |
| | | | acid | | | | | |
| Example 7 | 7 | ATO | Acetic | 1.00 | ODA | 297.6 | 0.25 | IPA |
| | | | acid | | | | | |
| Example 8 | 8 | ATO | Acetic | 1.00 | TUA | 479.9 | 0.25 | IPA |
| | | | acid | | | | | |
| Example 9 | 9 | ATO | Acetic | 0.10 | TOA | 353.7 | 0.25 | IPA |
| | | | acid | | | | | |
| Example 10 | 10 | ATO | Acetic | 1.00 | DTA | 409.8 | 0.25 | IPA |
| | | | acid | | | | | |
| Comparative | 11 | ATO | Acetic | 1.00 | DIA | 101.2 | 1.00 | IPA |
| Example 1 | | | acid | | | | | |
| Comparative | 12 | ATO | Acetic | 1.00 | TDA | 522.0 | 0.25 | IPA |
| Example 2 | | | acid | | | | | |

In Table 1, ATO is antimony-containing tin oxide, TOA is tri-n-octylamine (manufactured by Kishida Chemical Co., Ltd.), TBA is tri-n-butylamine (manufactured by Kishida Chemical Co., Ltd.), THA is tri-n-hexylamine (manufactured by Kishida Chemical Co., Ltd.), ODA is dimethyl-n-octadecylamine (manufactured by Tokyo Chemical Industry Co., Ltd.), TUA is tri-n-undecylamine (manufactured by Tokyo Chemical Industry Co., Ltd.), DTA is di-n-tetradecylamine (manufactured by Tokyo Chemical Industry Co., Ltd.), DIA is diisopropylamine (manufactured by Kishida Chemical Co., Ltd.), TDA is tri-n-dodecylamine (manufactured by Tokyo Chemical Industry Co., Ltd.), IPA is isopropyl alcohol, and the content is the content (parts by mass) relative to 100 parts by mass of ATO particles.

Table 2 shows the results of measuring the pH and average particle diameter of the dispersion liquids described in Examples 1 to 10 and Comparative Examples 1 and 2.

TABLE 2

| | | pH of dispersion liquid | | | | | |
|---|---|---|---|---|---|---|---|
| | | | pH after | pH after | | | |
| | | pH 1 | evaporation (pH 2) | evaporation (pH 3) | Dispersion stability of ATO particles | | |
| | | Concentration | Concentration of | Concentration of | | | Rate of change |
| | Dispersion | of ATO: 20% | ATO: 50% by | ATO: 80% by | Initial | After 1 month | over one month |
| | liquid No. | by mass | mass | mass | nm | nm | [%] |
| Example 1 | 1 | 4.7 | 2.6 | 2.2 | 528.1 | 541.7 | 2.5 |
| Example 2 | 2 | 4.0 | 2.5 | 2.2 | 443.7 | 451.9 | 1.8 |
| Example 3 | 3 | 5.7 | 3.0 | 2.5 | 709.1 | 732.3 | 3.2 |
| Example 4 | 4 | 5.5 | 2.9 | 2.5 | 497.9 | 515.1 | 3.3 |
| Example 5 | 5 | 4.8 | 2.7 | 2.4 | 571.3 | 588.1 | 2.9 |
| Example 6 | 6 | 4.4 | 2.6 | 2.3 | 557.4 | 575.2 | 3.1 |
| Example 7 | 7 | 4.7 | 2.5 | 2.2 | 569.8 | 590.4 | 3.5 |
| Example 8 | 8 | 4.5 | 2.6 | 2.3 | 446.1 | 451.3 | 1.2 |
| Example 9 | 9 | 5.9 | 5.5 | 3.1 | 459.5 | 469.9 | 2.2 |
| Example 10 | 10 | 4.9 | 2.7 | 2.5 | 451.3 | 463.3 | 2.6 |
| Comparative | 11 | 4.6 | 2.7 | 2.5 | 1360.4 | 4435.1 | 69.3 |
| Example 1 | | | | | | | |
| Comparative | 12 | 4.4 | 2.7 | 2.5 | 443.1 | 446.1 | 0.7 |
| Example 2 | | | | | | | |

In the table, the rate of change over one month indicates the rate of change in the average particle diameter over one month.

Table 3 shows the results of measuring the surface resistivity and haze value of the resin films produced using the coating materials described in Examples 1 to 10 and Comparative Examples 1 and 2.

TABLE 3

| | Coating | Formulation | | | Evaluation results | |
|---|---|---|---|---|---|---|
| | material for | | | Content | Surface resistivity | |
| | forming resin | Dispersion | | (parts by | of coating film | Haze |
| | film No. | liquid No. | Resin | mass) | (LOG Ω/□) | value |
| Example 1 | 1 | 1 | PETA | 30.0 | 9.77 | 0.2 |
| Example 2 | 2 | 2 | PETA | 30.0 | 10.34 | 0.1 |
| Example 3 | 3 | 3 | PETA | 30.0 | 9.22 | 0.5 |
| Example 4 | 4 | 4 | PETA | 30.0 | 10.15 | 0.2 |
| Example 5 | 5 | 5 | PETA | 30.0 | 9.41 | 0.3 |
| Example 6 | 6 | 6 | PETA | 30.0 | 9.58 | 0.3 |
| Example 7 | 7 | 7 | PETA | 30.0 | 9.61 | 0.4 |
| Example 8 | 8 | 8 | PETA | 30.0 | 10.84 | 0.2 |
| Example 9 | 9 | 9 | PETA | 40.0 | 10.99 | 0.6 |
| Example 10 | 10 | 10 | PETA | 30.0 | 1048 | 0.3 |
| Comparative | 11 | 11 | PETA | 30.0 | 8.94 | 2.2 |
| Example 1 | | | | | | |
| Comparative | 12 | 12 | PETA | 30.0 | 12.87 | 0.1 |
| Example 2 | | | | | | |

In the table, resin indicates the resin precursor, PETA indicates pentaerythritol tri- and tetraacrylate (product name: Aronix M-305, manufactured by Toagosei Co., Ltd.), and the content indicates the content (parts by mass) of ATO particles per 100 parts by mass of the resin precursor.

### [Evaluation Results]

The evaluation results of the Examples and Comparative Examples are explained below.

The dispersion liquids of Examples 1 to 3 and Example 9 contain acetic acid as an acidic compound in an amount of 0.10 parts by mass to 2.00 parts by mass per 100 parts by mass of ATO particles, and tri-n-octylamine as a basic compound in an amount of 0.25 parts by mass to 1.00 part by mass per 100 parts by mass of ATO particles. From the results in Table 2, the rate of change of the average particle diameter of the ATO particles was 4% or less when comparing the average particle diameter immediately after preparation with that after one month, thereby confirming high dispersibility. In other words, this suggests that a good pot life was obtained due to the dispersion stabilization effect of tri-n-octylamine.

Furthermore, the surface resistivity of the resin film shown in Table 3 was 9.22 to 10.99 (LOG Ω/□), respectively, and electrical conductivity could be imparted. The haze value of the resin film also showed that the film had good transparency.

The reason why electrical conductivity was exhibited in the state of resin film while high dispersion stability was achieved in the state of dispersion liquid is considered to be as follows. In the state of dispersion liquid, the pH is higher than the isoelectric point of the ATO particles, which is from 2.0 to close to 4.0, so the dispersion is stable. As shown in the results in Table 2, this is thought to be because the pH approaches the isoelectric point of the ATO particles in the process in which the dispersion medium evaporates after coating on the base material. The results in Table 2 show that the pH of the dispersion liquid decreases as isopropyl alcohol, which is the dispersion medium, evaporates.

In Example 4, a dispersion liquid was prepared using malic acid as the acidic compound. In Examples 5 to 8 and 10, the basic compound was changed to tri-n-butylamine (TBA: molecular weight 185.4), tri-n-hexylamine (THA: molecular weight 269.5), dimethyl-n-octadecylamine (ODA: molecular weight 295.5), tri-n-undecylamine (TUA: molecular weight 479.9), and di-n-tetradecylamine (DTA: molecular weight 409.8), respectively, to prepare the ATO dispersion liquids.

From the results of Example 4, it can be seen that even when malic acid is used as the acidic compound, a dispersion liquid can be obtained that can form a highly conductive film while stably maintaining the dispersion state of the conductive particles for a long period of time.

Furthermore, from the results of Examples 5 to 8 and 10, it can be seen that if an amine compound having a molecular weight of 180 to 500 and a specific structure is used as the basic compound, a dispersion liquid can be obtained that can form a highly conductive film while stably maintaining the dispersion state of conductive particles for a long period of time.

In Comparative Example 1, a dispersion liquid was prepared using diisopropylamine (IDA: molecular weight 101.2) as the basic compound. In this case, since the molecular weight of IDA is small, the dispersion stabilization effect of the ATO particles in the dispersion liquid was not sufficient, the average particle diameter of the ATO particles changed significantly from immediately after preparation to one month later, and the pot life of the dispersion liquid was reduced. From this, it can be seen that the molecular weight of the amine compound needs to be 180 or more.

In Comparative Example 2, tri-n-dodecylamine (TDA: molecular weight 522.0) was used as the basic compound. In this case, the molecular weight of the basic compound was sufficiently large, so that the ATO particles were highly stable over time due to strong steric repulsion between them. However, the surface resistivity of the resin film obtained using this dispersion liquid was 12.87 (LOG Ω/□), which was close to insulation, and the resin film had low conductivity. This is thought to be because the ATO highly dispersed by TDA is unlikely to form a conductive path in the resin film. For this reason, the molecular weight of the amine compound needs to be 500 or less.

According to at least one aspect of the present disclosure, it is possible to obtain a dispersion liquid of conductive particles that can form a highly conductive film while stably maintaining the dispersion state of the conductive particles for a long period of time. In addition, according to at least one aspect of the present disclosure, it is possible to obtain a coating material for forming a resin film that can stably form a highly conductive resin film. Furthermore, according to at least one aspect of the present disclosure, it is possible to obtain a resin film having high conductivity. Furthermore, according to at least one aspect of the present disclosure, it is possible to obtain a member having a highly conductive surface.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A dispersion liquid comprising antimony-containing tin oxide particles, an acidic compound, a basic compound, and a dispersion medium, wherein
the basic compound has a molecular weight of 180 to 500 and is at least one compound selected from the group consisting of secondary amines and tertiary amines represented by a following formula (1),
the dispersion liquid has a pH higher than an isoelectric point of the antimony-containing tin oxide particles, and the pH of the dispersion liquid assumes a value closer to the isoelectric point during a process of evaporating the dispersion medium from the dispersion liquid: 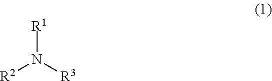
(In formula (1), R¹ and R² each independently represent an aliphatic hydrocarbon group, and R³ represents a hydrogen atom or an aliphatic hydrocarbon group.).

2. The dispersion liquid according to claim 1, wherein
a content of the acidic compound is 0.10 parts by mass to 2.00 parts by mass relative to 100 parts by mass of the antimony-containing tin oxide particles, and
a content of the basic compound is 0.25 parts by mass to 1.00 parts by mass relative to 100 parts by mass of the antimony-containing tin oxide particles.

3. The dispersion liquid according to claim 2, wherein a content ratio of the antimony-containing tin oxide particles in the dispersion liquid is 5% by mass to 50% by mass.

4. The dispersion liquid according to claim 1, wherein the acidic compound is an organic acid.

5. The dispersion liquid according to claim 1, wherein the dispersion medium is an organic solvent.

6. A coating material for forming a resin film comprising a resin, the coating material comprising:
at least one selected from the group consisting of the resin and a precursor of the resin,
antimony-containing tin oxide particles,
an acidic compound,
a basic compound, and
an organic solvent, wherein
the basic compound has a molecular weight of 180 to 500 and is at least one compound selected from the group consisting of secondary amines and tertiary amines represented by a following formula (1),
the coating material has a pH higher than an isoelectric point of the antimony-containing tin oxide particles, and the pH of the coating material assumes a value closer to the isoelectric point during a process of evaporating the dispersion medium from the coating material, and
the organic solvent is capable of dissolving at least a part of the resin and the precursor of the resin: 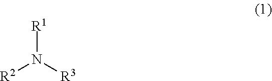
(In formula (1), R¹ and R² each independently represent an aliphatic hydrocarbon group, and R³ represents a hydrogen atom or an aliphatic hydrocarbon group.).

7. The coating material according to claim 6, wherein the resin is an acrylic resin.

8. The coating material according to claim 6, wherein the organic solvent comprises isopropyl alcohol and methyl ethyl ketone.

9. A resin film comprising a resin, the resin film being a cured product of a coating film of the coating material according to claim 6.

10. A member comprising:
a base material; and
a resin film comprising a resin on a surface of the base material, wherein
the resin film is a cured product of a coating film of the coating material according to claim 6.
